(19) United States
(12) Patent Application Publication
(10) Pub. No.: US 2025/0315459 A1
(43) Pub. Date: Oct. 9, 2025

(54) TERMINAL, CONTROL METHOD OF TERMINAL AND NON-TRANSITORY COMPUTER-READABLE STORAGE MEDIUM

(71) Applicant: NEC Corporation, Tokyo (JP)

(72) Inventors: Shinji CHICHIBU, Tokyo (JP); Takeyoshi OE, Tokyo (JP); Hinami Mitomi, Tokyo (JP); Kazufumi Hoshi, Tokyo (JP); Asaki Sannomiya, Tokyo (JP)

(73) Assignee: NEC Corporation, Tokyo (JP)

(21) Appl. No.: 19/096,826

(22) Filed: Apr. 1, 2025

(30) Foreign Application Priority Data
Apr. 5, 2024 (JP) 2024-061191

(51) Int. Cl. G06F 16/3329

(52) U.S. Cl. CPC G06F 16/33295

(57) ABSTRACT

A terminal includes an acquiring means and a control means. The acquiring means acquires an operation history of each of a plurality of applications installed in own apparatus. The control means generates a prompt to be input into a language model using the operation history of an application selected by a user from among the plurality of applications as the application for which the user requests an explanation of a method of using. The control means presents to the user an explanatory text related to a method of using the selected application, the explanatory text being acquired from the language model using the generated prompt.

### INCORPORATION BY REFERENCE

This application is based upon and claims the benefit of priority from Japanese Patent Application No. 2024-061191, filed on Apr. 5, 2024, the disclosure of which is incorporated herein in its entirety by reference.

### TECHNICAL FIELD

The present invention relates to a terminal, a control method of a terminal, and a non-transitory computer-readable storage medium.

### BACKGROUND ART

There are technologies that support usage of programs (applications), and so on installed on personal computers, or the like.

For example, Patent Literature 1 (JP2006-285820 A) describes providing a support data display system that makes it possible to present accurate support information, especially to users who are not familiar with using programs.

The system of Patent Literature 1 stores in advance support data corresponding to each of a plurality of error information that occurs while a program is running, and stores a start-up history of the program once the program is started. If an error occurs while the program is running, the system counts the number of occurrences for each error information.

Furthermore, at the time of displaying support data, the system selects and displays the support data corresponding to the error information from among the error information corresponding to the most recently started program in descending order of the number of errors that have occurred.

A wide variety of applications are installed on terminals such as smartphones. Because so many applications are installed on a terminal, even users who are accustomed to handling smartphones may not know how to use the applications. In such cases, the users may refer to an instruction manual for the application, and so on, however, it may be difficult to identify the necessary item from among the many items described in the instruction manual.

### SUMMARY

It is a main object of the present invention to provide a terminal, a control method of a terminal and a non-transitory computer-readable storage medium that contribute to enabling a user to easily know how to use an application installed in a smartphone, and so on.

According to a first aspect of the present invention, there is provided a terminal including: an acquiring means that acquires an operation history of each of a plurality of applications installed in own apparatus; and a control means that generates a prompt to be input into a language model using the operation history of an application selected by a user from among the plurality of applications as the application for which the user requests an explanation of a method of using, and presents to the user an explanatory text related to a method of using the selected application, the explanatory text being acquired from the language model using the generated prompt.

According to a second aspect of the present invention, there is provided a control method of a terminal, the control method including: an acquiring step that acquires an operation history of each of a plurality of applications installed in own apparatus; and a control step that generates a prompt to be input into a language model using the operation history of an application selected by a user from among the plurality of applications as the application for which the user requests an explanation of a method of using, and presents to the user an explanatory text related to a method of using the selected application, the explanatory text being acquired from the language model using the generated prompt.

According to a third aspect of the present invention, there is provided a non-transitory computer-readable storage medium storing a program mounted on a terminal to perform processing for: an acquiring processing that acquires an operation history of each of a plurality of applications installed in own apparatus; and a control processing that generates a prompt to be input into a language model using the operation history of an application selected by a user from among the plurality of applications as the application for which the user requests an explanation of a method of using, and presents to the user an explanatory text related to a method of using the selected application, the explanatory text being acquired from the language model using the generated prompt.

### BRIEF DESCRIPTION OF THE DRAWINGS

Exemplary features and advantages of the present invention will become apparent from the following detailed description when taken with the accompanying drawings in which:

FIG. 1 is a diagram illustrating an outline of an example embodiment;

FIG. 2 is a flowchart illustrating an outline of an operation of an example embodiment;

FIG. 3 is a diagram illustrating an example of a schematic configuration of an information processing system according to an example embodiment of the present disclosure;

FIG. 4 is a diagram illustrating an example of a display of a terminal according to the example embodiment of the present disclosure;

FIG. 5 is a diagram illustrating an operation of the information processing system to the example embodiment of the present disclosure;

FIG. 6 is a diagram illustrating an example of a display of the terminal according to the example embodiment of the present disclosure;

FIG. 7 is a diagram illustrating an example of a processing configuration of the terminal according to the example embodiment of the present disclosure;

FIG. 8 is a diagram illustrating an example of an operation history management database according to the example embodiment of the present disclosure;

FIG. 9 is a flowchart illustrating an example of an operation of a usage method control unit according to the example embodiment of the present disclosure;

FIG. 10 is a diagram illustrating an example of a processing configuration of the terminal to according to the example embodiment of the present disclosure; and

FIG. 11 is a diagram illustrating an example of a hardware configuration of the terminal according to the present disclosure.

### EXAMPLE EMBODIMENT

First, an outline of an example embodiment will be described. In the following outline, various components are denoted by reference characters for the sake of convenience. That is, the following reference characters are used as examples to facilitate the understanding of the present invention. Thus, the description of the outline is not intended to impose any limitations. In addition, unless otherwise specified, an individual block illustrated in the drawings represents a configuration of a functional unit, not a hardware unit. An individual connection line between blocks in the drawings signifies both one-way and two-way directions. An arrow schematically illustrates a principal signal (data) flow and does not exclude bidirectionality. In the present description and drawings, elements that can be described in a like way will be denoted by a like reference character, and redundant description thereof will be omitted as needed.

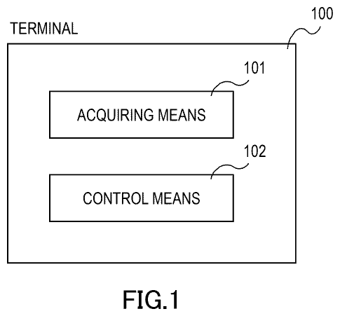

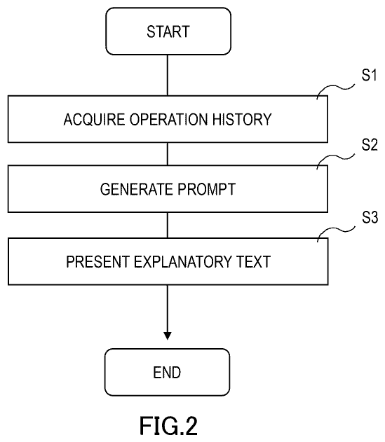

A terminal 100 according to an example embodiment includes an acquiring means 101 and a control means 102 (see FIG. 1). The acquiring means 101 acquires an operation history of each of a plurality of applications installed in own apparatus (step S1 in FIG. 2). The control means 102 generates a prompt to be input into a language model using the operation history of the application selected by a user from among a plurality of applications as the application for which the user requests an explanation of a method of using the application (step S2). The control means 102 presents to the user an explanatory text related to a method of using the selected application, the explanatory text being acquired from the language model using the generated prompt (step S3).

The terminal 100 acquires and stores a history of an operation performed by a user on an application. Once the user requests an explanation of how to use the application, the terminal 100 generates a prompt using the operation history, generates an explanatory text of the application using the generated prompt and the language model, and presents the explanatory text to the user. By using the operation history of the application, the terminal 100 estimates the matters, and so on that the user wants to know about the application, and generates a prompt so that the explanatory text for the estimated matters is acquired. As a result, the user can acquire an explanation of how to use the application installed on a smartphone, and so on that the user really wants to know about.

Hereinafter, specific example embodiments will be described in more detail with reference to drawings.

### First Example Embodiment

A first example embodiment will be described in more detail with reference to drawings.

### System Configuration

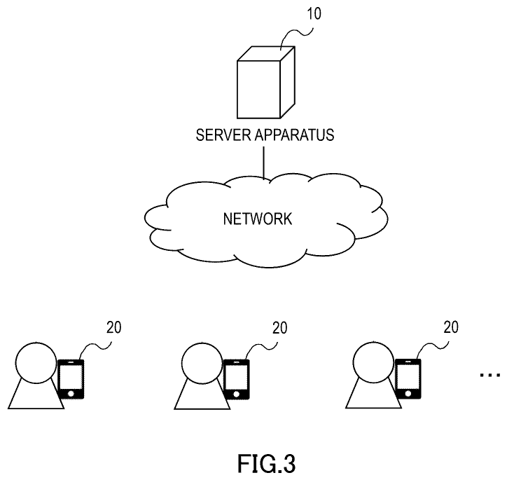

FIG. 3 is a diagram illustrating an example of a schematic configuration of an information processing system according to an example embodiment of the present application. As shown in FIG. 3, the information processing system includes a server apparatus 10.

The server apparatus 10 is a server that provides various information to a user. More specifically, the server apparatus 10 is a server that provides an interactive AI (Artificial Intelligence) service using a language model. For example, a large language model (LLM) is implemented in the server apparatus 10. The server apparatus 10 is installed, for example, on a network (in a cloud).

A user possesses a terminal 20, such as a smartphone. Various applications are installed on the terminal 20. The user uses an application installed on the terminal 20 to communicate with others using a social networking service (SNS) or to shop online at an electronic commerce (EC) site.

Each apparatus (server apparatus 10, terminal 20) shown in FIG. 3 is connected by wired or wireless communication means and is configured to be able to communicate with each other.

The configuration of the information processing system shown in FIG. 3 is an example, and is not intended to limit the configuration of the information processing system. For example, a plurality of server apparatus 10 may be included in the system. Load balancing and redundancy may be achieved by the plurality of server apparatuses 10.

### Outline of Operation

Next, a schematic operation of the information processing system according to the first example embodiment will be described.

### Input of User Information

A user registers his/her own information on the terminal 20 by operating the terminal 20. For example, the user registers his/her name, gender, date of birth, address, biometric information (for example, face image), and so on the terminal 20. The terminal 20 stores the acquired name, and so on, internally.

### Operation History of Application

The user uses an application installed on the terminal 20. Here, each application installed on the terminal 20 generates an operation history of an operation performed by the user. More specifically, for each application, the operation history that includes a date and time of the operation, a content of the operation (a selected menu, information on a pushed button or link, a page from which a transition occurred, and a page to which the transition occurred) is generated.

### Explanation of How to Use the Application

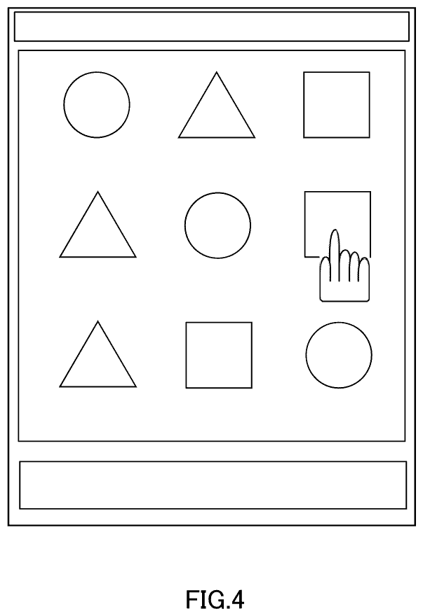

There are cases where the user does not know how to use the application. In such cases, the user performs an operation on the terminal 20 to request an explanatory text related to a method of using the application. For example, the user requests the explanatory text of the application by pressing and holding an icon corresponding to the application displayed on a screen of the terminal 20 (see FIG. 4). The terminal 20 generates the explanatory text related to the method of using the application using attribute information of the user and/or the operation history of the application. More specifically, the terminal 20 acquires the explanatory text related to the method of using the above-mentioned application from the server apparatus 10 that provides an interactive service using a large-scale language model.

For example, the terminal 20 generates a prompt that acquires the method of using the application from the large-scale language model by using the attribute information of the user and the operation history of the application.

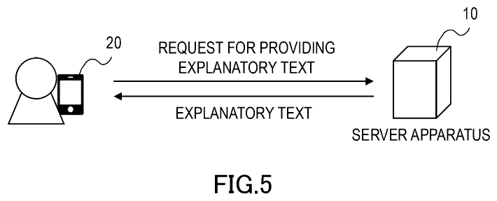

The terminal 20 transmits a “request for providing an explanatory text” including the generated prompt to the server apparatus 10 (see FIG. 5). The server apparatus 10 generates the explanatory text related to the method of using the application by inputting the prompt included in the received request for providing an explanatory text into the large-scale language model. The server apparatus 10 transmits the generated explanatory text to the terminal 20.

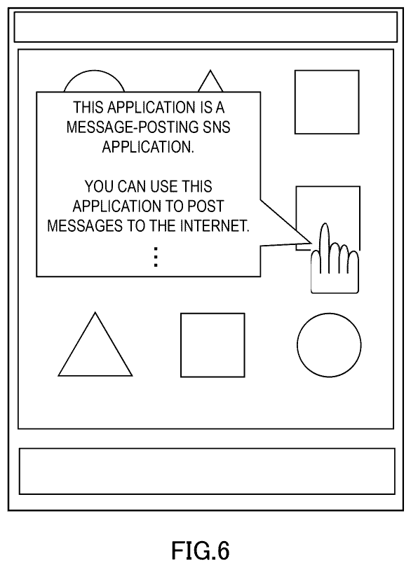

The terminal 20 presents the received explanatory text to the user. For example, the terminal 20 displays a screen, as shown in FIG. 6, to show the user the explanatory text related to the method of using the application for which the user does not know how to use.

Next, details of the individual apparatuses included in the information processing system according to the first example embodiment will be described.

### Terminal

Examples of the terminal 20 include a portable terminal device such as a smartphone, a portable phone, a game console, or a tablet and a computer (a personal computer or a laptop computer). The terminal 20 can be any equipment or device as long as the terminal 20 can accept an operation by a user and can communicate with the server apparatus 10, and so on.

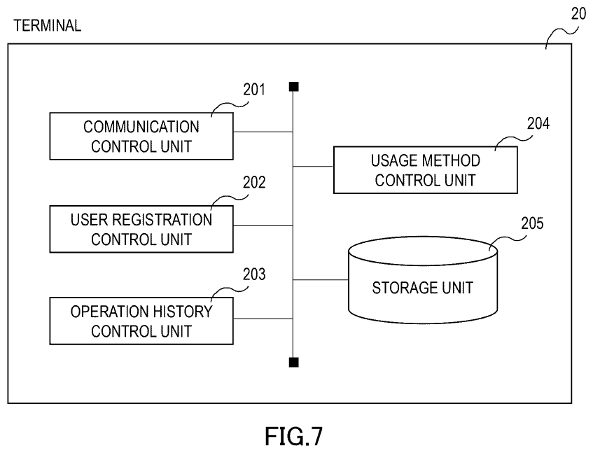

FIG. 7 is a diagram illustrating an example of a processing configuration (processing modules) of the terminal 20 according to an example embodiment of the present application. Referring to FIG. 7, the terminal 20 includes a communication control unit 201, a user registration control unit 202, an operation history control unit 203, a usage method control unit 204, and a storage unit 205.

The communication control unit 201 is means for controlling communication with other apparatuses. For example, the communication control unit 201 receives data (packets) from the server apparatus 10. In addition, the communication control unit 201 transmits data to the server apparatus 10. The communication control unit 201 gives data received from other apparatuses to other processing modules. The communication control unit 201 transmits data acquired from other processing modules to other apparatuses. In this way, other processing modules transmit and receive data to and from other apparatuses via the communication control unit 201. The communication control unit 201 includes a function as a receiving unit that receives data from other apparatuses and a function as a transmitting unit that transmits data to other apparatuses.

Here, among the processing modules of the above-mentioned terminal 20, the user registration control unit 202, the operation history control unit 203, and the usage method control unit 204 may be implemented as functions of an operating system (OS) installed in the terminal 20.

The user registration control unit 202 is means for performing control related to registration of user information. Once a user has performed a predetermined operation (for example, pressing a user registration button) by operating the terminal 20, the user registration control unit 202 acquires information on the user.

For example, the user registration control unit 202 displays a GUI (Graphical User Interface) on the terminal 20 and acquires a name, gender, date of birth, address, biometric information, and so on. The user registration control unit 202 stores the acquired name, and so on, in the storage unit 205.

The operation history control unit 203 is means for performing control related to a history that occurs at the time a user uses each application. The operation history control unit 203 includes a function as an acquiring means to acquire an operation history of each of a plurality of applications installed in its own apparatus (the terminal 20).

Once each application installed on the terminal 20 has acquired an operation by the user, it notifies the operation history control unit 203 of the content (details) of the acquired operation.

For example, once each application is launched by the user, it notifies the operation history control unit 203 of an application name (application ID) and a launch date and time as the operation history. Alternatively, once the user presses a button, each application notifies the operation history control unit 203 of the application name, an operation date and time, the type of button pressed, and so on as the operation history. Alternatively, once the user presses a link, each application notifies the operation history control unit 203 of the application name, operation date and time, a page from which the link was transitioned, a page to which the link was transitioned, and so on as the operation history.

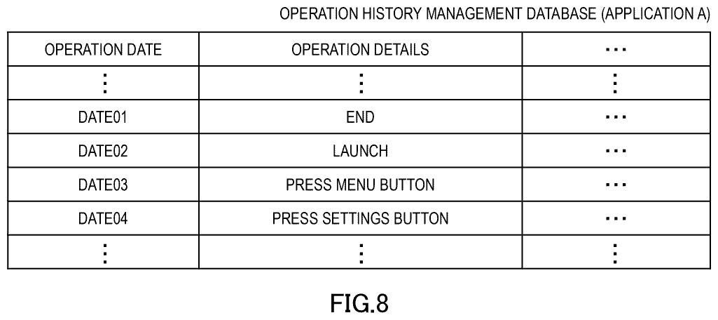

The operation history control unit 203 stores the operation history acquired from each application for each application. The operation history control unit 203 stores the operation history in an operation history management database prepared for each application (see FIG. 8).

Note that the operation history management database shown in FIG. 8 is an example of a database that manages the operation history for Application A. Furthermore, the operation history management database shown in FIG. 8 is an example, and is not intended to limit the items to be stored, and so on. For example, the operation history for each of a plurality of applications may be managed and stored in the same database.

The usage method control unit 204 is means for performing control related to the method of using each application installed in the terminal 20.

The usage method control unit 204 generates a prompt to be input into the language model using the operation history of the application selected by the user from among a plurality of applications as the application for which the user requests an explanation of the method of using. The usage method control unit 204 presents to the user an explanatory text related to the method of using the selected application acquired from the language model using the generated prompt.

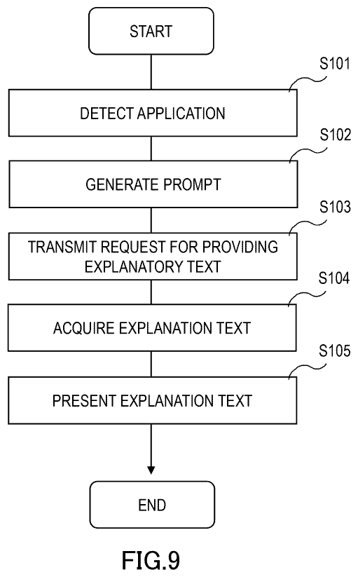

FIG. 9 is a flowchart illustrating an example of an operation of the usage method control unit 204 according to an example embodiment of the present invention. Referring to FIG. 9, the operation of the usage method control unit 204 will be described.

The usage method control unit 204 detects an application for which the user requests an explanation of the method of using the application (step S101).

For example, the usage method control unit 204 detects a predetermined action performed by the user on an icon corresponding to each application on a home screen. For example, usage method control unit 204 detects that the user has pressed and held down the icon. The usage method control unit 204 identifies the application corresponding to the icon that the user has pressed and held down as the application for which an explanation of the method of using the application is requested.

The usage method control unit 204 generates a prompt to be transmitted to the server apparatus 10 using the attribute information of the user and/or operation history of the application for which the explanation of the method of using the application is requested (step S102).

Note that a specific example of the prompt generated by the usage method control unit 204 will be described below.

The usage method control unit 204 sends a “request for providing an explanatory text” including the generated prompt to the server apparatus 10 (step S103).

The usage method control unit 204 acquires the explanation text (response to the request for providing an explanatory text) from the server apparatus 10 (step S104).

The usage method control unit 204 presents the acquired explanatory text to the user (step S105). For example, the usage method control unit 204 displays the explanatory text of the application in the vicinity of the icon corresponding to the application for which the user requests the explanation of the method of using the application, as shown in FIG. 6.

In this way, the usage method control unit 204 acquires the explanatory text related to the method of using the application selected by the user by transmitting the generated prompts to the server apparatus 10 in which the large-scale language model is implemented.

The storage unit 205 is means for storing information necessary for the operation of the terminal 20.

### Server Apparatus

A detailed description of the server apparatus 10 will be omitted. The server apparatus 10 is a server that provides an interactive AI (Artificial Intelligence) service using a general-purpose (commercial) large-scale language model. The server apparatus 10 is implemented with a language model acquired through machine learning using a vast amount of learning data, including instruction manuals for various applications that can be installed on smart phones, and so on.

The server apparatus 10 may input the prompt included in the “request for providing an explanatory text” received from the terminal 20 into the large-scale language model and transmit an answer from the large-scale language model to the terminal 20.

### Specific Examples

Next, specific examples of a prompt generated by the usage method control unit 204 of the terminal 20 will be described.

For example, the usage method control unit 204 acquires the most recent operation content of the target application for which a request for providing an explanatory text has been made. The usage method control unit 204 generates a prompt to be transmitted to the server apparatus 10 using the acquired content of the operation.

For example, if the user presses the “unsubscribe button” in Application A, the usage method control unit 204 generates a prompt such as “Please create an explanatory text in the case where the unsubscribe button of Application A is pressed.”

In this case, the server apparatus 10 generates, for example, the explanatory text describing the procedure to unsubscribe from a service provided by using Application A.

Alternatively, the usage method control unit 204 identifies the most recent screen transition in the target application based on the operation history of the application. For example, the usage method control unit 204 grasps that the display on the terminal 20 has transitioned from a menu screen to a settings screen by the user pressing a link embedded in Application A. In this case, the usage method control unit 204 generates a prompt such as “Please generate a detailed explanatory text regarding the settings of Application A.”

In this case, the server apparatus 10 generates the explanatory text of the items, and so on that can be set in Application A.

In this way, the usage method control unit 204 may generate a prompt using the most recent operation content of the application selected by the user (the operation history of the operation performed immediately preceding the timing at which the user has requested an explanation).

Alternatively, the usage method control unit 204 may calculate a cumulative usage time for the target application based on the operation history of the application, and generate a prompt using the calculated cumulative usage time. For example, in the case where Application A has just been launched for the first time since Application A has been installed on the terminal 20 (in the case where the cumulative usage time is substantially zero), the usage method control unit 204 generates a prompt such as “Please give me an overview of Application A.”

In this case, the server apparatus 10 generates an explanatory text including an outline of the functions of Application A and information, and so on about a business operator that provides Application A.

In this way, the usage method control unit 204 may calculate the cumulative usage time of the application selected by the user based on the operation history of the selected application, and generate a prompt using the calculated cumulative usage time.

Alternatively, the usage method control unit 204 may calculate a usage frequency of the target application based on the operation history of the application, and generate a prompt using the calculated usage frequency. For example, in the case where Application A is a frequently used application (for example, an application launched 10 or more times per day), the usage method control unit 204 generates a prompt such as “Please tell me about a less known function of Application A.”

In this case, the server apparatus 10 generates an explanatory text related to a minor function of Application A.

Alternatively, the usage method control unit 204 may generate a prompt requesting to provide an explanatory text for the target application based on the operation history of a plurality of applications. For example, the usage method control unit 204 calculates the frequency of use of each application that is similar to the target application. If the similar application is used more frequently, the usage method control unit 204 generates a prompt such that the difference between the operation of the similar application and the operation of the target application is acquired as an explanatory text.

For example, consider a case in which Application A and Application B are similar applications and Application B is used more frequently and an explanation of Application A is requested. In this case, the usage method control unit 204 generates a prompt such as “Please generate an explanatory text regarding the differences between the operation of Application A and the operation of Application B with respect to the operation of Application A.”

In this case, the server apparatus 10 generates an explanatory text regarding the different function, and how to use between applications A and B.

In this way, the usage method control unit 204 may generate a prompt using the operation history of the application selected by the user and the operation history of an application different from the application selected by the user.

Alternatively, the usage method control unit 204 may generate a prompt requesting to provide an explanatory text for the target application based on attribute information of the user (for example, age, gender). For example, the usage method control unit 204 generates a prompt such as “Please generate an explanatory text for Application A aimed at men in their 70s.”

In this case, the server apparatus 10 generates an explanatory text regarding the method of using Application A according to the age and gender of the user.

Alternatively, the usage method control unit 204 may use an attribute of the user and the operation history to generate a prompt requesting the user to provide an explanatory text for the target application. For example, the usage method control unit 204 generates a prompt such as “Please generate an explanatory text for a male in his 70s who is using Application A for the first time.”

As described above, the terminal 20 according to the first example embodiment accumulates a history of an operation history performed by a user on an application. Once a predetermined operation by the user (for example, pressing and holding an icon) is detected, the terminal 20 generates a prompt using the operation history of the application, and transmits the generated prompt to the server apparatus 10. The server apparatus 10 generates an explanatory text of the application by inputting the acquired prompt into a large-scale language model, and transmits the explanatory text to the terminal 20. The terminal 20 presents the acquired explanatory text to the user. The terminal 20 uses the operation history of the application to estimate matters, and so on that the user wants to know about the application, and to estimate the situation (status) of the use of the application by the user. The terminal 20 generates the prompt so that the explanatory text of the estimated matter and the explanatory text suitable for the situation of the use by the user are acquired from the large-scale language model. As a result, the terminal 20 can present the explanatory text suitable for the user.

Sometimes, a user does not know how to use an application installed on the terminal 20. In this case, the user performs a predetermined operation on the terminal 20 (for example, pressing and holding the icon for the application that the user does not know how to use). Once the terminal 20 detects the predetermined operation by the user, the terminal 20 presents an explanatory text suitable for the user, taking into account the attribute of the user and the situation with the application, instead of a normal manual for the application. In other words, the terminal 20 presents a personalized explanatory text (explanatory information) to the user by using the operation history, and so on of the application. Since the user can immediately access the information that the user wants to know, convenience for the user is improved.

### Second Example Embodiment

Next, a second example embodiment will be described in detail with reference to drawings.

In the first example embodiment, the case is described where the language model (large-scale language model) for generating the explanatory text of the application is implemented in the server apparatus 10. The second example embodiment will describe a case in which the language model is implemented inside the terminal 20.

The following description will be made with a focus on the difference between the first example embodiment and the second example embodiment.

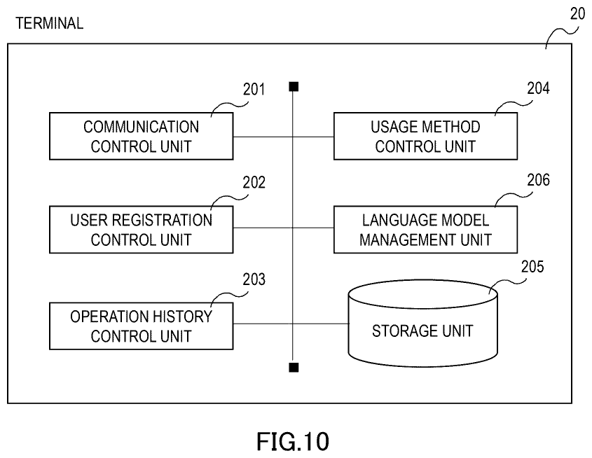

FIG. 10 is a diagram illustrating an example of a processing configuration (processing module) of the terminal 20 according to an example embodiment of the present application. Referring to FIG. 10, a language model management unit 206 is added to the configuration of the terminal 20 according to the first example embodiment.

The language model management unit 206 is means for performing control and management for the language model used in an explanatory text of an application.

The language model management unit 206 acquires a language model prepared by a system administrator, or the like. For example, the language model management unit 206 acquires the language model using a GUI, and so on. Alternatively, the language model management unit 206 may acquire the language model via USB (Universal Serial Bus) memory, and so on.

The language model is a machine learning model (also called a generative model) that inputs language and outputs language. The language model learns the relationships between words in a sentence, and is the model that generates a related character string from a target character string that is related to the target character string. By using the language model that has learned sentences and phrases in various contexts, it is possible to generate the related character string with appropriate content that is related to the target character string.

The learning method of the language model is not particularly limited, but as an example, the language model may be trained to output at least one sentence that includes the input character string. As a specific example, the language model is a GPT (Generative Pre-Transformer) that outputs a sentence including the input character string by predicting a character string that has a high probability of following the input character string.

Other examples of language models include, for example, T5 (Text-to-Text Transfer Transformer), BERT (Bidirectional Encoder Representations from Transformers), RoBERTa (Robustly optimized BERT approach), ELECTRA (Efficiently Learning an Encoder that Classifies Token Replacements Accurately), and so on.

The language model is generated based on training data. For example, the language model specialized for generating an explanatory text of the application (a small-scale language model) is implemented in the terminal 20. In this case, a variety of training data such as manuals for applications that may be installed in the terminal 20, information on the Internet (for example, information provided by SNS and blogs), and so on are used to train and learn the learning model.

Instead of transmitting a request for providing an explanatory text to the server apparatus 10, the usage method control unit 204 according to the second example embodiment inputs a prompt generated based on the operation history of the application, and so on, into the language model implemented in its own apparatus. The usage method control unit 204 presents an answer (explanatory text of the application) acquired by inputting the prompt into the language model to the user.

As described above, the terminal 20 in the second example embodiment acquires an explanatory text related to the method of using the application selected by the user by inputting the generated prompts in the language model implemented inside its own apparatus. Since the language model is implemented inside the terminal 20, the terminal 20 can provide an explanatory text for the application to the user even if the terminal 20 is offline.

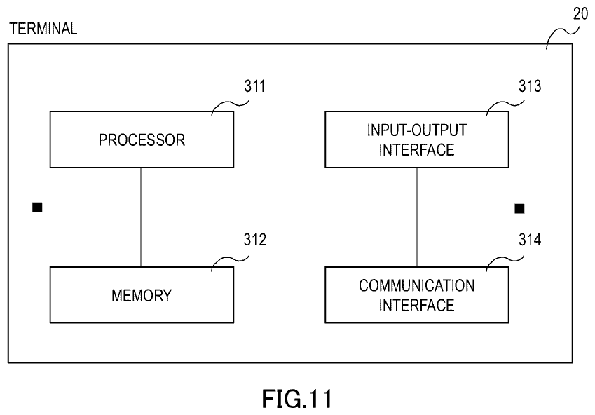

Next, a hardware configuration of an individual apparatus that constitutes the information processing system will be described. FIG. 11 is a diagram illustrating an example of a hardware configuration of the terminal 20.

The terminal 20 can be configured by an information processing apparatus (a so-called computer) and has a configuration illustrated as an example in FIG. 11. For example, the terminal 20 includes a processor 311, a memory 312, an input-output interface 313, a communication interface 314, etc. The components such as the processor 311 are connected to an internal bus, and so on so that these components can communicate with each other.

The hardware configuration of the terminal 20 is not limited to the configuration illustrated in FIG. 11. The terminal 20 may include hardware not illustrated or may be configured without the input-output interface 313 if desired. In addition, the number of components, such as the number of processors 311, included in the terminal 20 is not limited to the example illustrated in FIG. 11. For example, a plurality of processors 311 may be included in the terminal 20.

For example, the processor 311 is a programmable device such as a CPU (Central Processing Unit), an MPU (Micro Processing Unit), or a DSP (Digital Signal Processor). Alternatively, the processor 311 may be a device such as an FPGA (Field Programmable Gate Array) or an ASIC (Application Specific Integrated Circuit). The processor 311 executes various kinds of programs including an operating system (OS).

The memory 312 is a RAM (Random Access Memory), a ROM (Read-Only Memory), an HDD (Hard Disk Drive), an SSD (Solid State Drive), or the like. The memory 312 stores an OS program, an application program, and various kinds of data.

The input-output interface 313 is an interface for a display apparatus and an input apparatus not illustrated. For example, the display apparatus is a liquid crystal display and so on. For example, the input device is a device, such as a keyboard, a mouse or a touch panel which receives user operations.

The communication interface 314 is a circuit, a module, and so on for performing communication with other apparatuses. For example, the communication interface 314 includes a NIC (Network Interface Card) and so on.

The functions of the terminal 20 are realized by various kinds of processing modules. The processing modules are realized, for example, by causing the processor 311 to execute a program stored in the memory 312. In addition, this program can be recorded in a computer-readable storage medium. The storage medium may be a non-transient (non-transitory) storage medium, such as a semiconductor memory, a hard disk, a magnetic recording medium, or an optical recording medium. That is, the present invention can be embodied as a computer program product. In addition, the above program may be updated by downloading a program via a network or by using a storage medium in which a program is stored. In addition, the above processing modules may be realized by semiconductor chips.

As is the case with the server apparatus 10 can each be configured by an information processing apparatus, and the basic hardware configuration of the server apparatus 10 is the same as that of the terminal 20. Thus, description of the basic hardware configuration of the server apparatus 10 will be omitted.

The terminal 20 includes a computer and can realize its functions by causing the computer to execute a program. In addition, the terminal 20 executes control method of a terminal 20 by using this program.

### Variations

The configurations, operations, and so on of the information processing system according to the above example embodiments are examples and do not limit the present system configuration, and so on.

The terminal 20, at the time of presenting an explanatory text of an application to a user, may change a display style of the explanatory text to be presented in accordance with attribute information of the user. For example, the usage method control unit 204 may change a font, font size, font color, and so on of the explanatory text to be presented in accordance with the age (generation) and gender of the use

In the above example embodiments, the case is described where the terminal 20 transmits a prompt to be input into the language model to server apparatus 10. However, the terminal 20 may transmit information used in generating the prompt (for example, attribute information of a user, operation history of an application) to the server apparatus 10. The server apparatus 10 may generate the prompts based on the acquired operation history of the application.

In the above example embodiments, the case is described where the function of presenting an explanatory text of the terminal 20 is realized by the OS installed on the terminal 20. However, the function of presenting an explanatory text may also be realized by each application. In other words, the function of presenting an explanatory text described above may be implemented in each of a plurality of applications.

In the above example embodiments, the case is described where the terminal 20 transmits a request for providing an explanatory text that includes a prompt to the server apparatus 10 in which a general-purpose large-scale language model is implemented. However, the terminal 20 may transmit a request for providing an explanatory text that includes a prompt to a server (application server; not shown in FIG. 3, and so on) managed and operated by a business operator or the like that provides the target application. The application server may generate an answer (explanatory text) using a language model acquired using an instruction manual or the like related to the application provided by the own company or the like, and transmit the generated explanatory text to the terminal 20.

The terminal 20 may accumulate explanatory texts (answers) acquired from the language model and generate an answer history. The usage method control unit 204 may generate a prompt to be input into the language model using the answer history in addition to the attribute information of the user and the operation history of the application. Specifically, the usage method control unit 204 may generate a prompt to prevent the language model from outputting duplicate answers.

The language model implemented in the server apparatus 10, and so on may provide the confidence level for the answer (the degree of appropriateness of the answer) to the terminal 20 along with the generated explanatory text. The usage method control unit 204 may determine the manner in which the explanatory text is displayed based on the acquired confidence level. For example, the usage method control unit 204 may use larger sized text for presenting an explanatory text with a high confidence level, and use smaller sized text for presenting an explanatory text with a low confidence level.

The server apparatus 10 and the terminal 20 may perform retraining of the language model. For example, the terminal 20 presents a prompt to be input to the language model and an explanatory text acquired from the language model to a developer, or the like of the application. The application developer, or the like evaluates the relationship between the input (prompt) and output (explanatory text) of the language model, and inputs the result of the evaluation to the terminal 20. The terminal 20 retrains the language model using the prompt, explanatory text, and the results of the evaluation by the application developer. As a result, the performance (output accuracy) of the language model is improved.

The terminal 20 may acquire an evaluation (evaluation from a user) of an explanatory text presented to the user. For example, the usage method control unit 204 may acquire an evaluation from the user such as “the explanatory text was helpful” or “the explanatory text was not helpful”. In addition, the usage method control unit 204 may also transmit the acquired evaluation to the server apparatus 10, and so on. For example, the usage method control unit 204 transmits to the server apparatus 10 the prompt transmitted to the server apparatus 10, the answer (explanatory text) acquired from the server apparatus 10, and the evaluation of the user for the explanatory text. The server apparatus 10 may use the acquired evaluation, and so on to retrain (feedback) the language model to improve the accuracy of the answer of the language model.

Alternatively, in the case where the terminal 20 receives an evaluation from the user such as “the explanatory text was not helpful,” the terminal 20 may re-present another explanatory text that is different from the previously presented explanatory text. For example, the usage method control unit 204 transmits to the server apparatus 10 a prompt that instructs to generate an explanatory text for a different matter than the previous explanatory text, and acquires the other explanatory text. Alternatively, the usage method control unit 204 may transmit to the server apparatus 10 a prompt that instructs to generate an explanatory text for a plurality of matters, and acquire the explanatory text for the plurality of matters. The usage method control unit 204 may present the plurality of acquired explanatory texts to the user. Further, in this case, the usage method control unit 204 may acquire the explanatory text that the user considers to be the most helpful explanatory text from among the plurality of explanatory texts. Retraining may be performed using the acquired most helpful explanatory text.

The above example embodiments describes the case where the operation history management database is configured inside the server apparatus 10, but the database may be established on an external database server, or the like. That is, some of the functions of the server apparatus 10 may be implemented in another apparatus. More specifically, the “usage method control unit (usage method control means)”, and so on described above, can be implemented in any of the apparatuses included in the system.

While the data exchange between each apparatus (for example, the server apparatus 10 and the terminal 20) is not limited to any particular mode, data exchanged between these apparatuses may be encrypted. It is desirable that personal information of a user, and so on are transmitted and received between these apparatuses and encrypted data is transmitted and received in order to properly protect this information.

In the flowcharts and sequence diagrams used in the above description, a plurality of steps (processes) are sequentially described. However, the order of the execution of the steps performed in the individual example embodiment is not limited to the described order. In the individual example embodiment, the order of the illustrated steps may be changed to the extent that a problem is not caused on the content of the individual example embodiment. For example, individual processes may be executed in parallel.

The above example embodiments have been described in detail to facilitate the understanding of the present application disclosed and not to mean that all the configurations described above are needed. In addition, if a plurality of example embodiments have been described, each of the example embodiments may be used individually or a plurality of example embodiments may be used in combination. For example, part of a configuration according to one example embodiment may be replaced by a configuration according to another example embodiment. For example, a configuration according to one example embodiment may be added to a configuration according to another example embodiment. In addition, addition, deletion, or replacement is possible between part of a configuration according to one example embodiment and another configuration.

The industrial applicability of the present invention has been made apparent by the above description. That is, the present invention is suitably applicable, for example, to an information processing system or the like that presents a user with how to use an application.

A part or the entirety of the example embodiments described above may be described as in the following supplementary notes, but is not limited to the followings.

### Supplementary Note 1

A terminal, including:
an acquiring means that acquires an operation history of each of a plurality of applications installed in own apparatus; and
a control means that generates a prompt to be input into a language model using the operation history of an application selected by a user from among the plurality of applications as the application for which the user requests an explanation of a method of using, and presents to the user an explanatory text related to a method of using the selected application, the explanatory text being acquired from the language model using the generated prompt.

### Supplementary Note 2

The terminal according to supplementary note 1, wherein the control means generates the prompt using a most recent operation content of the selected application.

### Supplementary Note 3

The terminal according to supplementary note 1, wherein the control means calculates a cumulative usage time for the selected application based on the operation history of the selected application, and generates the prompt using the calculated cumulative usage time.

### Supplementary Note 4

The terminal according to supplementary note 1, wherein the control means calculates a usage frequency of the selected application based on the operation history of the selected application, and generates the prompt using the calculated usage frequency.

### Supplementary Note 5

The terminal according to supplementary note 1, wherein the control means generates the prompt using the operation history of the selected application and the operation history of an application different from the selected application.

### Supplementary Note 6

The terminal according to any one of supplementary notes 1 to 5, wherein the control means generates the prompt using attribute information of the user.

### Supplementary Note 7

The terminal according to supplementary note 6, wherein the control means acquires the explanatory text related to the method of using the selected application by transmitting the generated prompt to a server apparatus in which the language model is implemented.

### Supplementary Note 8

The terminal according to supplementary note 6, wherein the control means acquires the explanatory text related to the method of using the selected application by inputting the generated prompt into the language model internally implemented.

### Supplementary Note 9

A control method of a terminal, the control method including:
an acquiring step that acquires an operation history of each of a plurality of applications installed in own apparatus; and
a control step that generates a prompt to be input into a language model using the operation history of an application selected by a user from among the plurality of applications as the application for which the user requests an explanation of a method of using, and presents to the user an explanatory text related to a method of using the selected application, the explanatory text being acquired from the language model using the generated prompt.

### Supplementary Note 10

The control method of the terminal according to supplementary note 9, wherein the control step generates the prompt using a most recent operation content of the selected application.

### Supplementary Note 11

The control method of the terminal according to supplementary note 9, wherein the control step calculates a cumulative usage time for the selected application based on the operation history of the selected application, and generates the prompt using the calculated cumulative usage time.

### Supplementary Note 12

The control method of the terminal according to supplementary note 9, wherein the control steps calculates a usage frequency of the selected application based on the operation history of the selected application, and generates the prompt using the calculated usage frequency.

### Supplementary Note 13

The control method of the terminal according to supplementary note 9, wherein the control step generates the prompt using the operation history of the selected application and the operation history of an application different from the selected application.

### Supplementary Note 14

The control method of the terminal according to any one of supplementary notes 9 to 13, wherein the control step generates the prompt using attribute information of the user.

### Supplementary Note 15

The control method of the terminal according to supplementary note 14, wherein the control step acquires the explanatory text related to the method of using the selected application by transmitting the generated prompt to a server apparatus in which the language model is implemented.

### Supplementary Note 16

The control method of the terminal according to supplementary note 14, wherein the control step acquires the explanatory text related to the method of using the selected application by inputting the generated prompt into the language model internally implemented.

### Supplementary Note 17

A program mounted on a terminal to perform processing for:
an acquiring processing that acquires an operation history of each of a plurality of applications installed in own apparatus; and
a control processing that generates a prompt to be input into a language model using the operation history of an application selected by a user from among the plurality of applications as the application for which the user requests an explanation of a method of using, and presents to the user an explanatory text related to a method of using the selected application, the explanatory text being acquired from the language model using the generated prompt.

### Supplementary Note 18

The program according to supplementary note 17, wherein the control processing generates the prompt using a most recent operation content of the selected application.

### Supplementary Note 19

The program according to supplementary note 17, wherein the control processing calculates a cumulative usage time for the selected application based on the operation history of the selected application, and generates the prompt using the calculated cumulative usage time.

### Supplementary Note 20

The program according to supplementary note 17, wherein the control processing calculates a usage frequency of the selected application based on the operation history of the selected application, and generates the prompt using the calculated usage frequency.

### Supplementary Note 21

The program according to supplementary note 17, wherein the control processing generates the prompt using the operation history of the selected application and the operation history of an application different from the selected application.

### Supplementary Note 22

The program according to according to any one of supplementary notes 17 to 21, wherein the control processing generates the prompt using attribute information of the user.

### Supplementary Note 23

The program according to supplementary note 22, wherein the control processing acquires the explanatory text related to the method of using the selected application by transmitting the generated prompt to a server apparatus in which the language model is implemented.

### Supplementary Note 24

The program according to supplementary note 22, wherein the control processing acquires the explanatory text related to the method of using the selected application by inputting the generated prompt into the language model internally implemented.

Furthermore, all or part of the configurations described in supplementary note 2 to supplementary note 8, which depend on supplementary note 1, may also depend on supplementary note 9 and supplementary note 17 in the same manner as supplementary note 2 to supplementary note 8. Furthermore, not limited to supplementary note 1, supplementary note 9, and supplementary note 17, within the scope that does not deviate from the embodiments described above, all or part of the configurations described as supplementary notes may similarly depend on various hardware, software, various recording means for recording software, or systems.

The entire disclosure of the above patent literature is incorporated herein by reference thereto. While the example embodiments of the present invention have thus been described, the present invention is not limited to these example embodiments. It is to be understood to those skilled in the art that these example embodiments are only examples and that various variations are possible without departing from the scope and spirit of the present invention. That is, the present invention of course includes various variations and modifications that could be made by those skilled in the art in accordance with the overall disclosure including the claims and the technical concept.

The previous description of embodiments is provided to enable a person skilled in the art to make and use the present disclosure. Moreover, various modifications to these example embodiments will be readily apparent to those skilled in the art, and the generic principles and specific examples defined herein may be applied to other embodiments without the use of inventive faculty. Therefore, the present disclosure is not intended to be limited to the example embodiments described herein but is to be accorded the widest scope as defined by the limitations of the claims and equivalents. Further, it is noted that the inventor's intent is to retain all equivalents of the claimed disclosure even if the claims are amended during prosecution.

What is claimed is:

1. A terminal, comprising:
at least one memory storing a set of instructions; and
at least one processor configured to execute the set of instructions to:
acquire an operation history of each of a plurality of applications installed in own apparatus;
generate a prompt to be input into a language model using the operation history of an application selected by a user from among the plurality of applications as the application for which the user requests an explanation of a method of using; and
present to the user an explanatory text related to a method of using the selected application, the explanatory text being acquired from the language model using the generated prompt.

2. The terminal according to claim 1, wherein
the at least one processor is further configured to execute the set of instructions to generate the prompt using a most recent operation content of the selected application.

3. The terminal according to claim 1, wherein
the at least one processor is further configured to execute the set of instructions to calculate a cumulative usage time for the selected application based on the operation history of the selected application, and generate the prompt using the calculated cumulative usage time.

4. The terminal according to claim 1, wherein
the at least one processor is further configured to execute the set of instructions to calculates a usage frequency of the selected application based on the operation history of the selected application, and generate the prompt using the calculated usage frequency.

5. The terminal according to claim 1, wherein
the at least one processor is further configured to execute the set of instructions to generate the prompt using the operation history of the selected application and the operation history of an application different from the selected application.

6. The terminal according to claim 1, wherein
the at least one processor is further configured to execute the set of instructions to generate the prompt using attribute information of the user.

7. The terminal according to claim 2, wherein
the at least one processor is further configured to execute the set of instructions to generate the prompt using attribute information of the user.

8. The terminal according to claim 3, wherein
the at least one processor is further configured to execute the set of instructions to generate the prompt using attribute information of the user.

9. The terminal according to claim 4, wherein
the at least one processor is further configured to execute the set of instructions to generate the prompt using attribute information of the user.

10. The terminal according to claim 5, wherein
the at least one processor is further configured to execute the set of instructions to generate the prompt using attribute information of the user.

11. The terminal according to claim 6, wherein
the at least one processor is further configured to execute the set of instructions to acquire the explanatory text related to the method of using the selected application by transmitting the generated prompt to a server apparatus in which the language model is implemented.

12. The terminal according to claim 6, wherein
the at least one processor is further configured to execute the set of instructions to acquire the explanatory text related to the method of using the selected application by inputting the generated prompt into the language model internally implemented.

13. A control method of a terminal, the control method comprising:
acquiring an operation history of each of a plurality of applications installed in own apparatus;
generating a prompt to be input into a language model using the operation history of an application selected by a user from among the plurality of applications as the application for which the user requests an explanation of a method of using; and
presenting to the user an explanatory text related to a method of using the selected application, the explanatory text being acquired from the language model using the generated prompt.

14. A non-transitory computer-readable storage medium storing a program mounted on a terminal to perform processing for:
acquiring an operation history of each of a plurality of applications installed in own apparatus;
generating a prompt to be input into a language model using the operation history of an application selected by a user from among the plurality of applications as the application for which the user requests an explanation of a method of using; and
presenting to the user an explanatory text related to a method of using the selected application, the explanatory text being acquired from the language model using the generated prompt.
